(19) United States
(12) Patent Application Publication
(10) Pub. No.: US 2007/0168673 A1
(43) Pub. Date: Jul. 19, 2007

(54) Method of allocating payload bits of a watermark

(75) Inventors: Minne Van Der Veen, Eindhoven (NL); Aweke Negash Lemma, Eindhoven (NL); Antonius Adrianus Cornelis Maria Kalker, Mountain View, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,928

(22) PCT Filed: Jan. 12, 2005
(86) PCT No.: PCT/IB05/50137

§ 371 Date: Jun. 29, 2006

(30) Foreign Application Priority Data
Jan. 15, 2004 (EP) 04100118.1

(51) Int. Cl. H04L 9/00

(52) U.S. Cl. 713/181

(57) ABSTRACT

A method of dynamically allocating payload bits in a watermarking system (10) is provided. The method including steps of: (a) determining one or more parameters to be conveyed in bits of a payload to be included in watermark information for embedding in programme content; (b) dynamically allocating the bits to corresponding of the one or more parameters so as to represent the one or more parameters in the payload; (c) including the payload in the watermark information; and (d) embedding the watermark information including the payload into the programme content. Such dynamic allocation of payload bits is capable of providing more effective use of payload capacity.

### FIELD OF THE INVENTION

The present invention relates to methods of allocating payload bits in watermarking systems for watermarking programme content, for example audio and/or video programme content. In particular, but not exclusively, the invention concerns a method of dynamically allocating payload bits between a plurality of payload functions in a watermarking system. Moreover, the invention also relates to watermarking systems operable to implement the method of dynamically allocating payload bits.

### BACKGROUND OF THE INVENTION

It is known to embed watermark information in programme content, for example into video programme content and audio programme content. The watermark information is embedded so that it is not obtrusive when the programme content is viewed and/or listened to by an end customer. Embedded watermark information is susceptible to being used in several ways:

(a) to convey information confirming authenticity of the programme content;

(b) to convey information concerning identity of the programme content in a form which is automatically machine readable; and

(c) to allow for user replay of programme content only if it is appropriately watermarked.

Data conveyed by way of the watermark information is known as a watermark payload, or simply “payload”.

It is known to embed dynamic watermarking data in programme content. For example, in international PCT patent application WO 03/055128 there is described aspects of digital watermarking involving utilizing a data stream to configure operations of an adaptive computing engine and embedding watermarking data within the data stream to provide identifying indicia for the adaptive computing engine.

The inventors have appreciated that watermark payload capacity is often limited for its intended application, namely it would be desirable in many cases to have more payload capacity available for conveying subsidiary data complementary to the programme content itself Consequently, payload design conventionally involves optimizing trade-offs available within programme content handling systems. In electronic music delivery (EMD) systems, such optimization concerns payload space allocated for representing:

(a) identity of the programme content, for example content identification (ID_{C}), namely the total number of different music items that can be uniquely represented;

(b) identity of the client, namely client identification (ID_{S});

(c) security information, for example security codes, public decryption keys and so forth; and

(d) detection reliability information, for example parity bits.

In order to address such payload restriction, the inventors have devised the present invention wherein data bits in a watermark payload are dynamically allocated to various functions. Such dynamical allocation is to be clearly distinguished from known watermarking schemes, for example that described in the aforementioned patent application WO 03/055128, in which the data of the payload may be dynamically altered but the partitioning of groups of bits within the payload allocated to specific functions remains static.

### OBJECT AND SUMMARY OF THE INVENTION

An object of the invention is to provide an improved method of allocating data bits within a payload of a watermark.

According to a first aspect of the present invention, there is provided a method of dynamically allocating payload bits in a watermarking system, the method including steps of:

(a) determining one or more parameters to be conveyed in bits of a payload to be included in watermark information for embedding in programme content;

(b) dynamically allocating the bits to corresponding of the one or more parameters so as to represent the one or more parameters in the payload;

(c) including the payload in the watermark information; and

(d) embedding the watermark information including the payload into the programme content.

The invention is of advantage in that it is capable of providing at least one of the following benefits:

(a) payload space is potentially used more effectively, thereby leading to a possibly higher communication capacity in a communication network arranged to distribute programme content;

(b) spare payload capacity, made available by more efficient use of payload capacity as a consequence of dynamic allocation of payload capacity, can be used to improve security; and

(c) dynamic payload allocation is susceptible to accommodating more easily system improvements, for example implementing electronic music delivery (EMD) systems in various phases so as to achieve backward compatibility.

The programme content relates to one or more of audio programme content, image programme content, and video programme content.

Preferably, in the method, the one or more parameters include at least one of: a content identifier (ID_{C}), a user identifier (ID_{S}), security information, redundancy checking (CRC). Such parameters are of especial benefit when distributing programme content for purposes of providing better detection of counterfeiting and/or pirating of copyright programme content.

Preferably, in the method, a dynamic allocation implemented in step (b) is made in response to at least one of:

(a) the nature of the programme content; and

(b) a potential number of users likely to request the programme content.

Preferably, in the method, a dynamic allocation implemented in step (b) is customized for each user requesting the programme content

Preferably, in the method, at least a portion of the parameters conveyed as dynamically allocated bits in the payload is in encrypted form. Such encryption is susceptible to deterring counterfeiters and/or hackers from copying and distributing the programme content.

Preferably, the method is adapted for use in electronic music delivery (EMD) systems.

Preferably, in the method, the dynamic allocation of bits of the payload is determined by at least one of:

(a) an audio fingerprint derived from the programme content;

(b) popularity of the programme content;

(c) a required level of security for the watermark information; and

(d) a required level of reliability of watermark information detection.

According to a second aspect of the invention, there is provided a watermarking system arranged to watermark programme content by utilizing the method according to the first aspect of the present invention.

According to a third aspect of the invention, there is provided watermark information for embedding in programme content, said information being generated by the method according to the first aspect of the invention.

According to a fifth aspect of the invention, there is provided watermarked programme content having embedded therein watermark information generated using a method according to the first aspect of the invention.

According to a sixth aspect of the invention, there is provided computer software arranged to be executable on one or more computing devices for implementing the method according to the first aspect of the invention.

It will be appreciated that features of the invention are susceptible to being combined in any combination without departing from the scope of the invention.

### DESCRIPTION OF THE DIAGRAMS

Embodiments of the invention will now be described, by way of example only, with reference to the following diagram wherein:

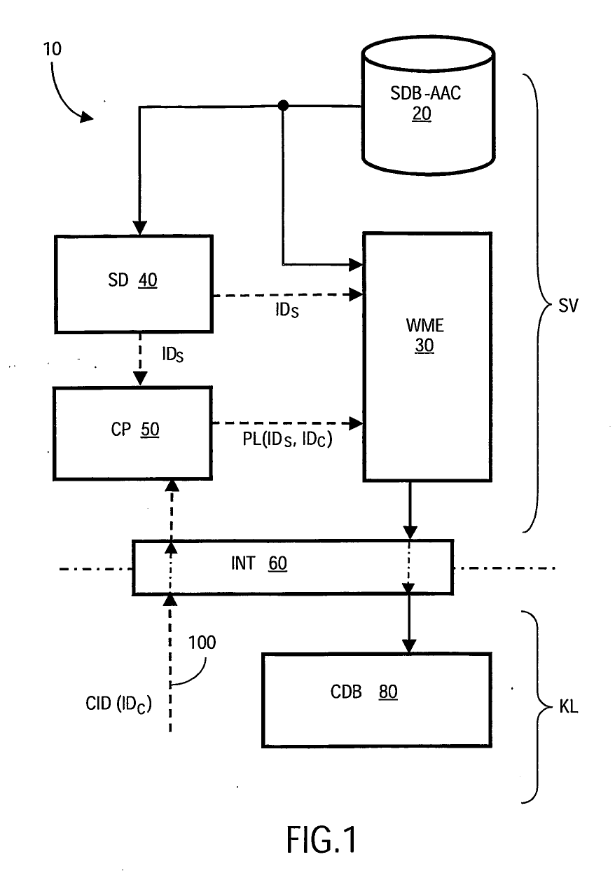

FIG. 1 is a schematic of a watermarked programme content distribution system according to the invention in which payload included in watermarks of watermarked programme content comprises data bits which are dynamically allocated according to function.

### DESCRIPTION OF EMBODIMENTS OF THE INVENTION

In contemporary watermarking system projects, it is an aim to develop electronic music delivery (EMD) systems. Such EMD systems are intended to give customers of programme content a perception of freedom to control the content, for example to copy the content, to distribute the content to friends and similar, namely activities which are of relevance when considering issues of potential infringement of copyright associated with the programme content. Thus, it is foreseen to employ passive copyright protection mechanisms.

Referring to FIG. 1, there is shown a schematic representation of a watermarked programme content distribution system indicated generally by 10. The system 10 comprises a server side (SV) and a client side (KL) mutually connected by way of a communication network (INT) 60, for example via the Internet The server side (SV) comprises a server database (SDB-AAC) 20, a seed generator (SD) 40, a payload creating function (CP) 50 and a watermarking engine (WME) 30. Moreover, the client side (KL) comprises a client database (CDB) 80 for example a hard disc drive associated with a computing device. Furthermore, parameters ID_{S}, ID_{C} concern a client identity and a programme content identity, respectively.

In operation, a client (KL) sends a request 100, namely CID(ID_{C}), for music programme content. The request 100 is conveyed via the communication network INT 60 to the payload creating function CP 50. Receipt of the request 100 prompt the server side SV to retrieve the requested programme content from the server database SDB-AAC 20. The retrieved requested programme content is then watermarked in the watermarking engine WME 30 wherein the programme content has embedded a user- and content-dependent watermark. After the requested content has been watermarked in the watermarking engine WME 30, the watermarked requested programme content is then shipped from the engine WME 30 via the communication network INT 60 to the user KL, for example for storing on the database CDB 80 for subsequent consumption by the user KL.

In the system 10, the retrieved requested programme content is watermarked with a watermark whose payload includes bits which are dynamically allocated to various different functions as elucidated in the foregoing. Thus, each time the programme content is retrieved and watermarked for subsequent shipping to users KL, it is potentially possible that different numbers of bits in the payloads of the watermarks embedded are allocated to specific functions, for example ID_{C} and/or security features. Preferably, the allocation is made dependent on a fingerprint parameter, for example generated from a fingerprint system.

It is a general problem in watermarking system, and in EMD systems in particular, that payload capacity, namely bit-rate conveyable in the embedded watermark also known as “a watermarking channel”, is limited for its purpose. In contemporary EMD systems, payload bits are allocated in a static proportion to the content ID (ID_{C}), the client ID (ID_{S}), for protection such as encryption bits, for cyclical redundancy check (CRC), for security and for an indicator of information conveyed. In contradistinction to conventional payload structure, the present invention employs a method to optimize payload structure in a dynamic manner, for example with regard to a trade-off between information capacity, security and detection reliability.

Referring again to FIG. 1, the payload creating function CP 50 is operable to create the payload PL(ID_{S}, ID_{C}) according to a process as represented by Equation 1 (Eq. 1):
PL=[E_{P}(ID_{C};ID_{S};0000 . . . );CRC] Eq. 1
wherein the payload PL is by default preferably provided with cyclical redundancy coding CRC and includes an at least partially encrypted content E_{P} whose bits are dynamically apportioned between representing parameters, for example song identification ID_{C}, client identification ID_{S}, and security in the form of zero's padding. When decrypting the payload PL in watermark information extracted at the client side (KL), the zero's padding is beneficially used for prevent tampering to the payload.

In order to provide an example of a practical instantaneous dynamic bit allocation to the payload PL, reference is made to Table 1.

TABLE 1

| | Number of bits dynamically |
|---|---|
| Parameter | allocated to parameter |
| ID_{C} | 8 |
| ID_{S} | 30 |
| Zero's padding (security) | 10 |
| Cyclical redundancy checking, CRC | 7 |

By such a dynamic allocation, for example when delivering the watermarked programme content to a specific client, 8-bits corresponding to 256 states for ID_{C} allows 256 different songs to be represented. Moreover, 30-bits corresponding to approximate 1 billion states for ID_{S} allows the payload to be customized for 1 billion different clients. The total payload size is 55 bits (=8+30+10+7). It will be appreciated however that the allocation in Table 1 is potentially dynamically alterable from one client to another when delivering programme content to them from the server side SV; in this respect, it will be appreciated that reducing the ID_{S} bit allocation in favour of security will result in the payload being able to uniquely identify a smaller number of customers.

Dynamic allocation of payload bits to various functions will be further elucidated with an example: consider a popular pop song and a less popular jazz song. It is expected that the pop-song will be delivered to more clients than the jazz song. Therefore, it is prudent according to the invention to allocate more bits to the user identifier ID_{S} in the case of supplying the pop song to clients KL and less bits to the user identifier ID_{S} in the case of supplying the jazz song to clients KL. Besides security aspects, such dynamic allocation results in more effective usage of payload space and hence a potentially higher payload capacity for conveying additional data content.

With regard to a mechanism for dynamically allocating the bits of the payload PL between specific functions, it is elucidated in the foregoing that the allocation is preferably made depending on the nature of the programme content, for example in response to whether or not the content is a more popular or less popular item. Preferably, the payload creating function CP 50 is arranged to allocate use of bits within the payload PL pursuant to instruction from a song identifier unit, for example by way of an audio fingerprint.

The method of the invention is thus capable of resulting in better usage of payload space and hence more effective use of watermark capacity when sending watermarked data content to clients KL. Payload bits which are rendered free for alternative use as a consequence of more effective dynamic allocation of payload bits can be used to provide other functionality such as enhanced security. Moreover, such dynamic allocation of payload data is capable of providing backward compatibility which makes it easier for programme content suppliers, namely SV, to accommodate future upgrades with regard to watermark content and structure.

It will be appreciated that embodiments of the invention described in the foregoing are susceptible to being modified without departing from the scope of the invention as defined by the accompanying claims.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method of dynamically allocating payload bits in a watermarking system, the method including steps of:
(a) determining one or more parameters to be conveyed in bits of a payload to be included in watermark information for embedding in programme content;
(b) dynamically allocating the bits to corresponding of the one or more parameters so as to represent the one or more parameters in the payload;
(c) including the payload in the watermark information; and
(d) embedding the watermark information including the payload into the programme content.

2. A method according to claim 1, wherein the one or more parameters include at least one of: a content identifier (ID_{C}), a user identifier (ID_{S}), security information, redundancy checking (CRC).

3. A method according to claim 1, wherein a dynamic allocation implemented in step (b) is made in response to at least one of:
(a) the nature of the programme content; and
(b) a potential number of users likely to request the programme content.

4. A method according to claim 1, wherein a dynamic allocation implemented in step (b) is customized for each user requesting the programme content.

5. A method according to claim 1, wherein at least a portion of the parameters conveyed as dynamically allocated bits in the payload is in encrypted form.

6. A method according to claim 1 adapted for use in electronic music delivery (EMD) systems.

7. A method according to claim 1 wherein the dynamic allocation of bits of the payload is determined by at least one of:
(a) an audio fingerprint derived from the programme content;
(b) popularity of the programme content;
(c) a required level of security for the watermark information; and
(d) a required level of reliability of watermark information detection.

8. A watermarking system arranged to watermark programme content by utilizing the method according to claim 1.

9. Watermark information for embedding in programme content, said information being generated by a method according to claim 1.

10. Watermarked programme content having embedded therein watermark information generated using a method according to claim 1.

11. Computer software arranged to be executable on one or more computing devices for implementing the method according to claim 1.
